(19) United States
(12) Patent Application Publication
(10) Pub. No.: US 2006/0167235 A1
(43) Pub. Date: Jul. 27, 2006

(54) Process for the preparation of ayl diazonium salts and reaction with nucleophiles

(76) Inventor: David John Moody, Fife (GB)

Correspondence Address: MORGAN LEWIS & BOCKIUS LLP, 1111 PENNSYLVANIA AVENUE NW, WASHINGTON, DC, 20004, US

(21) Appl. No.: 10/559,834

(22) PCT Filed: Jun. 3, 2004
(86) PCT No.: PCT/GB04/02339

§ 371 Date: Mar. 28, 2006

(30) Foreign Application Priority Data
Jun. 7, 2003 (GB) 0313110.9

(51) Int. Cl. C09B 43/00

(52) U.S. Cl. 534/588

(57) ABSTRACT

A process for performing nucleophilic substitution reactions on aryl diazonium salts or derivatives thereof wherein the aryl diazonium salt is first generated in an aqueous solvent system followed by partitioning of the aryl diazonium salt with a hydrophobic ionic liquid thereby allowing subsequent reaction of the aryl diazonium salt with an appropriate nucleophilic species in the hydrophobic ionic liquid to the desired product without the need to first isolate the aryl diazonium salt.

The present invention relates to reactions of aryl diazonium salts and derivatives thereof, more particularly to the use of hydrophobic ionic liquids in such reactions.

Aromatic diazonium salts are used in a variety of chemical reactions and are important compounds due to their extensive use in for example, the manufacture of functionalised dyes and substituted aromatic compounds, most commonly halo-aromatic compounds.

Diazotisation reactions commonly involve the oxidation of amines using nitrous acid to form diazonium salts. In practice, these salts are usually prepared in solution at 0-5° C. because the compounds readily lose nitrogen on heating and are highly explosive in the dry state.

Included in the important reactions of aryl diazonium salts are substitution reactions in which the diazonium group (—N₂⁺), is replaced for example, by a nucleophile such as a halogen or nitrile group. For some synthetic reactions involving diazonium salts, the salts have to be isolated prior to further reaction to the desired compound, even though the diazonium salts are inherently unstable and have the potential to explode.

Furthermore, in reactions where the diazonium salts are not isolated, the yield of the desired product may be significantly decreased as a result of competing nucleophilic reactions.

Therefore, there is a requirement for a process whereby aryl diazonium salts can be prepared and utilized to give the desired aromatic product in high yield without the need to isolate the diazonium salts per se thereby avoiding the inherent danger associated with the use and reactions of diazonium salts.

Laali and Gettwert (Journal of Fluorine Chemistry 107(2001), 31) describe how the Balz-Schiemann reaction can be performed in ionic liquids solvents by the addition of an isolated diazonium tetrafluoroborate salt to a dried ionic liquid under inert conditions. Also described in this reference is an in situ diazotisation reaction under inert conditions using a nitrosium salt (nitrosium tetrafluoroborate (NO⁺BF₄⁻) or nitrosium hexafluorophosphate (NO⁺PF₆⁻)). The use of trifluoroacetate (CF₃CO2⁻), triflate (⁻OTf) or tosylate (⁻OTs) based ionic liquids resulted in the nucleophilic addition of these ionic liquid co-anions to the aryl cation. The required fluorinated aromatic compounds were only achieved when anhydrous conditions were employed, that is, the utilisation of isolated and dried diazonium salts and dried ionic liquids. Furthermore, the in situ diazotisation reaction described in the above reference is inherently slow and utilises expensive reagents.

In U.S. Pat. No. 4,265,810, a process for recovering zwitterionic diazonium salts derived from aromatic amines is disclosed. The patent discloses how zwitterionic diazonium salts are aggregated by diazotisation in the presence of cationic surfactants so as to achieve diazonium salt particles that can be readily separated from the liquid mass in which they are formed. There is no disclosure of the use of hydrophobic ionic liquids.

We have now surprisingly found that through the use of hydrophobic ionic liquids, diazonium salts can be reacted in situ with for example an appropriate nucleophile to give the desired aryl compound without the need to isolate the diazonium salt and without the need for anhydrous conditions.

Therefore, according to the present invention there is provided a process for performing nucleophilic substitution reactions on aryl diazonium salts or derivatives thereof wherein the aryl diazonium salt is first generated in an aqueous solvent system followed by partitioning of the aryl diazonium salt with a hydrophobic ionic liquid thereby allowing subsequent reaction of the aryl diazonium salt with an appropriate nucleophilic species to the desired product in the hydrophobic ionic liquid without the need to first isolate the aryl diazonium salt.

Diazonium Salts

Aryl diazonium salts and derivatives thereof for use in accordance with the present invention are prepared using known reagents and diazotisation methods. An example of a known diazotisation method is the oxidation of aromatic amines in the presence of a suitable diazotising agent such as nitrous acid (HNO₂). Due to the instability of nitrous acid, it is generally prepared when required by the reaction of an alkali metal nitrite, with an acid.

Examples of inorganic nitrites suitable for use in the diazotisation reaction of the present invention include for example sodium nitrite, potassium nitrite and caesium nitrite. Examples of suitable organic nitrites include inter alia t-butyl nitrite and amyl nitrite. The most preferred nitrite is sodium nitrite.

Examples of suitable acids for use in the diazotisation methods include inorganic acids such as hydrochloric acid, sulphuric acid and tetrafluoroboric acid. Examples of suitable organic acids include trifluoroacetic acid and methanesulfonic acid. The most preferred form of acid for use in preparing aryl diazonium salts according to the present invention are inorganic acids such as for example hydrochloric or hydrobromic acid.

Examples of aromatic amines commonly used in the diazotisation reactions of the present invention have the general Formula (1):
ArNH₂ Formula (1)
wherein:
Ar is an optionally substituted mono or polycyclic aryl, optionally substituted mono or polycyclic aralkyl or optionally substituted mono or polycyclic heteroaryl moieties or combinations thereof.

When Ar is an optionally substituted mono or polycyclic aryl moiety, it is preferably an optionally substituted phenyl, naphthyl, biphenyl, benzofuranyl or dibenzofuranyl group. Most preferably it is an optionally substituted phenyl group.

When Ar is an optionally substituted mono or polycyclic aralkyl moiety, it is preferably optionally substituted benzyl, styrenyl or indenyl group.

When Ar is an optionally substituted mono or polycyclic heteroaryl moiety it is preferably an optionally substituted pyrazine, pyrimidine, thiazolyl, pyridyl, furanyl, pyranyl, quinoline or coumarin group.

Preferred optional substituents on the mono or polycyclic aryl, aralkyl and heteroaryl moieties include: optionally substituted C₁₋₁₀-alkyl, more preferably optionally substituted C₁₋₆-alkyl, C₁₋₄-alkoxy, hydroxy-C₁₋₄-alkoxy, (hydroxy-C₁₋₄-alkoxy)-C₁₋₄-alkoxy, —OH, —COOH, —PO₃H₂, —SO₃H, —CF₃, —CF₂CF₃, —NH₂, —NH(C₁₋₄-alkyl), —NH(hydroxy-C₁₋₄-alkyl), —N(hydroxy-C₁₋₄-alkyl)₂, —NH(—C(O)(C₁₋₄-alkyl)), —N(C₁₋₄-alkyl)₂, —N(C₁₋₄-alkyl)(—C(O)(C₁₋₄-alkyl)), halo (for example fluorine, chlorine or bromine), nitro, cyano, —C(O)(C₁₋₄alkyl), —SO₂(C₁₋₄alkyl), optionally substituted phosphoramide, —SC₁₋₆-alkyl, —S(hydroxy-C₁₋₄-alkyl), —SO₂C₁₋₆alkyl, —SO₂N(C₁₋₆-alkyl)₂, —SO₂N(hydroxy-C₁₋₆-alkyl)₂, —SOC₁₋₆alkyl, —OC₁₋₆-alkyl, —O(hydroxy-C₁₋₆-alkyl), —C(O)C₁₋₆alkyl, —C(O)C₁₋₄-alkoxy, —C(O)(hydroxy-C₁₋₄-alkyl), —C(O)N(C₁₋₄-alkyl)₂, —C(O)N(hydroxy-C₁₋₄-alkyl)₂, —C(O)NH(C₁₋₄-alkyl), optionally interrupted alkylene and alkenylene groups for example ethylene, 1,2-propylene, 1,3-propylene, 2-hydroxy-1,3-propylene, 1,4-butylene, 2,3-butylene and 2,4-butylene, 2-methyl-1,3-propylene, 2-methyl-2,4-pentylene, 2,2-dimethyl-1,3-propylene, 1-chloro-2,3-propylene, 1,6-hexylene, 1,5-hexylene, —CH₂NHCH₂—, 1-carboxy-1,5-pentylene, 2,7-heptylene, 3-methyl-1,6-hexylene, —CH₂CH═CHCH₂—, —CH₂CH₂OCH₂CH₂—, —CH₂CH₂SCH₂CH₂—, and —COOR wherein R is an optionally substituted alkyl, aryl or aralkyl moiety.

Preferred aromatic amines commonly used in the diazotisation reactions of the present invention are those in which ArNH₂ represents an optionally substituted aniline compound of Formula (2). 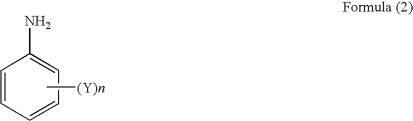
wherein :
Y is an optional substituent as hereinbefore described; and
n is 0, 1, 2or 3.

Preferred aromatic amines are those in which Y is a nitro, cyano, halo or an alkoxy group of the formula —OR¹, wherein R¹ is C₁₋₄alkoxy.

Especially preferred aromatic amines commonly used in the diazotisation process according to the present invention are those as illustrated in Formulae (3), (4) or (5): 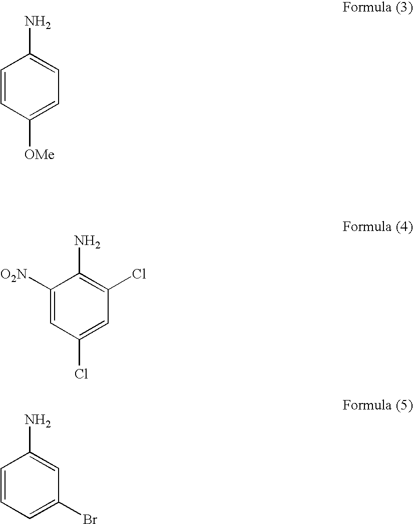
Ionic Liquids

Ionic liquids traditionally comprise one or more salts. When an ionic liquid comprises two salts, it is commonly referred to as a binary ionic liquid. When an ionic liquids comprises three salts, it is referred to as a ternary ionic liquid and so on. Such salts are usually formed by combining a large organic positive ion such as 1-ethyl-3-methyl imidazolium ([emim]+), with a variety of negative ions, such as tetrafluoroborate, (BF₄⁻) or hexafluorophosphate (PF₆⁻). This combination of large and small oppositely charged ions means that ionic liquids behave very differently to ionic salts such as sodium chloride. In sodium chloride, the oppositely charged ions are held together by ionic interactions resulting in an arrangement of the ions in a regular lattice. Whilst not wishing to be bound by any particular theory, in contrast to salts such as sodium chloride, in ionic liquids, the positively charged ions are large relative to the negatively charged ions, with the result that the positive charge is effectively ‘shared’ across the whole of the positive ions. Consequently, because of steric effects and/or the diffused ion charge, there is a larger distance between the ions in the ionic liquid, referred to as the inter-ion distance, with a subsequent lowering of the lattice energy associated with the ionic liquid salts. Consequently, the ionic liquid compounds are liquids at ambient temperature and pressure.

The hydrophobic ionic liquids according to the present invention are preferably able to form a biphasic solution when mixed with water at the desired temperature. The hydrophobic ionic liquids preferably comprise cations and anions and may be either organic or inorganic. Examples of suitable anions include halides, such as bis-(trifluoromethylsulfonyl)imide [NTf₂], hexafluorophoshate [PF₆⁻], tetrafluoroborate [BF₄⁻], dicyanamide, SO₄²⁻, HSO₄⁻, acetate, trifluoroacetate, phosphinate, triflate, tosylate, mesylate and perfluorobutyrate. In many cases, the phase separation between the ionic liquid and the water will be a function of temperature, and highly dependant upon the cation-anion combination. For example, [bmim][BF₄] is miscible with water at room temperature whereas [C₈pyridinium][BF₄] forms two phases at room temperature. Examples of suitable ionic liquids with the desired properties are disclosed in Rogers et al. Industrial & Engineering Chemistry Research (2003), 42(3), 413-418, incorporated herein by reference.

Preferred anions used for the ionic liquids in accordance with the present invention are fluorine compounds such as hexafluorophosphate (PF₆⁻), tetrafluoroborate (BF₄⁻) and bis(trifluoromethylsulfonyl)imide.

Preferred cations used for the ionic liquids in accordance with the present invention are based on quaternised nitrogen or phosphorous compounds, for example, 1-alkyl or aryl-3-imidazolium compounds, N-alkyl- and N-aryl-pyridinium, piperidinium, pyrollidinium, tetra-alkylammonium, tetra-alkylphosphonium, DBN (1,5-diazabicyclo[4.3.0]non-5-ene), DBU (1,8-diazabicyclo[5.4.0]undec-7-ene), pyrazolium, oxazolium, thiazolium and quinolinium. In accordance with the present invention any cations can be used so long as the ionic liquid is able to form a biphasic solution when mixed with water.

Additional properties of hydrophobic ionic liquids suitable for use in the present invention include insignificant vapour pressure at room temperature, high solvation capacity and a large liquid range, for example, 1-ethyl-3-methylimidazolium bis(trifluoromethylsulfonyl)imide ([emim][NTf₂]) has a liquid range of up to 400° C. Further properties of ionic liquids include the ability to operate as extremely good solvents for organic and charged species.

Examples of hydrophobic ionic liquids suitable for use in the present invention include 1-butyl-3-methyl-imidazolium hexafluorophosphate [bmim] [PF₆], (available under the tradename ACROS from Sachem), [emim][NTf₂] (available from Covalent Associates), [emim][PF₃(C₂F₅)₃] (available from Merck) and tetradecyltrihexyl phosphonium bromide (available from Cytec).

Preferred hydrophobic ionic liquids suitable for use in accordance with the present invention are selected from the group comprising [emim][NTf₂] 1-ethyl-3-methylimidazolium bis(trifluoromethylsulfonyl)imide, [bmim][PF₆] N-butylpyridinium hexafluorophosphate, [bbim][Br] 1-dibutyl-3-methy limidazolium bromide, and [C₄DBU]Br carbon tetra-1,8-diazabicyclo[5.4.0]undec-7-ene bromide.

It will be appreciated to those skilled in the art that the diazotisation reactions according to the present invention can also be performed in the presence of water miscible organic solvents provided that the water-miscible organic solvents do not interfere with the diazotisation reactions per se. However, it is preferred that the diazotisation reactions according to the present invention are performed in water alone in the absence of any water miscible organic solvents.

It will also be appreciated to those skilled in the art that the hydrophobicity of the reaction media in which the diazotisation reactions according to the present invention are performed can be modified for example by the use of two or more ionic liquids, or, by the use of a mixture of one or more ionic liquids in the presence or absence of certain water immiscible organic solvents. Water immiscible organic solvents are preferably chosen which do not interact with the ionic liquids and which are mutually soluble with the ionic liquids. Examples of suitable water immiscible organic solvents include for example chlorinated hydrocarbons, ketones, such as 4-methyl-2-pentanone (MIBK) and aromatic hydrocarbons. It is preferred however that the reactions of the aryl diazonium salts according to the present invention are not performed in the presence of water immiscible organic solvents.

Once formation of the aryl diazonium salt is complete, the aryl diazonium salt is partitioned into the hydrophobic ionic liquid layer in accordance with the present invention. The aryl diazonium salt can then be further reacted to give the desired end product. Reactions which can be performed with the aryl diazonium salts whilst the salt is in the hydrophobic ionic liquid layer include the Balz-Schiemann reaction and the Sandmeyer reaction.

The Balz-Schiemann reaction traditionally involves replacing the diazonium ion (—N₂⁺) on the aromatic ring of the aryl diazonium salt with fluorine that is, for example, a fluorodediazoniation reaction, such as the in situ thermal decomposition of an aryl diazonium salt to yield a fluoroarene. This regiospecific introduction of fluorine into aromatic, heteroaromatic and polyaromatic compounds is a valuable reaction in various fields of chemistry including pharmaceutical and agricultural research as well as the more classical area of dye chemistry.

The Balz-Schieman reaction typically involves introducing fluorine into an aromatic ring by heating fluoborate salts. The fluoborate salts are typically prepared by first carrying out a diazotisation reaction as described above using for example nitrous acid and hydrochloric acid (HCl) followed by the addition of a cold aqueous solution of NaBF₄, HBF₄ or NH₄BF₄. Alternatively, the reaction can be carried out directly using HBF₄ as the acid of diazotisation. In general, any aromatic amine which can be diazotised will form a BF₄⁻ salt.

Additional important reactions of aryl diazonium salts are substitution reactions with metal salts for example cuprous halides, including, chlorine, bromine, iodine or pseudohalides for example, nitrile or thiocyanate groups, in which the diazonium ion is replaced by an appropriate nucleophile. This type of aromatic nucleophilic substitution reaction of aryl diazonium salts is commonly known as the Sandmeyer reaction and typically requires the presence of copper. The Sandmeyer reaction is particularly important for the in situ reaction of aryl diazonium salts with cuprous bromide, chloride or cyanide to produce aryl halides and nitriles respectively. Aryl iodides may also be synthesised using a Sandmeyer type reaction wherein aryl diazonium salts are reacted with potassium iodide (KI). However, the Sandmeyer reaction fails when attempted with copper iodide or copper fluoride. Traditionally, if the nucleophilic species to be reacted with the diazonium salts is bromide, chloride or nitrile, then the nucleophilic species is usually introduced via the Sandmeyer reaction in the form of either the appropriate copper (I) salt in the form of copper (I) bromide, copper (I) chloride or copper (I) cyanide. In accordance with a further aspect of the present invention it has surprisingly now been found that nucleophilic species such as for example chlorine, bromine, iodine, nitrile or thiocyanate can be introduced via a hydrophobic ionic liquid and thereby reacted with the aryl diazonium salts such that there is no longer the requirement to supply the nucleophile as a copper salt. Consequently, such nucleophilic species are introduced in the hydrophobic ionic liquids as inorganic or organic salts containing the desired species for example, sodium cyanide (NaCN), tetraethylammonium cyanide or tetrabutylammonium bromide (TBAB).

It has also surprisingly been found that for Sandmeyer type reactions carried out using bromide introduced as the nucleophilic species in the hydrophobic ionic liquid enhanced yields of bromide substituted aryl compounds can be obtained compared with traditional Sandmeyer reactions performed in aqueous environments without using hydrophobic ionic liquids.

Experimental investigation according to the present invention has shown that Sandmeyer type reactions performed by replacing, for example, the metal salts such as cuprous halides and cyanides with hydrophobic ionic liquids resulted in increased selectivity of the desired aryl product when the reaction was carried out with hydrophobic ionic liquids compared with conventional copper reagents such that for example there was little or no phenol produced as a result of competing nucleophilic side reactions. Furthermore, the Sandmeyer type reactions performed in hydrophobic ionic liquids gave higher yields than the conventional reactions carried out with copper salts, and had the added advantage that for the hydrophobic ionic liquid reactions the disposal of heavy metal waste was avoided.

In a preferred embodiment of the present invention the nucleophilic species comprises F⁻, and the aryl nucleophilic substitution reaction is a Balz-Schiemann reaction. In an alternative preferred embodiment of the present invention the nucleophilic species comprises Cl⁻, Br⁻, CN⁻ or thiocyanate in which case the aryl nucleophilic substitution reaction is a Sandmeyer type reaction.

As described above when the nucleophilic species to be introduced into the aromatic ring in place of the diazonium moiety is fluorine, the fluorine is usually provided in the diazonium ionic liquid in the form of BF₄⁻.

When the nucleophilic species to be introduced into the aromatic ring in place of the diazonium moiety is Cl⁻, Br⁻, CN⁻ or thiocyanate the Cl⁻, Br⁻, CN⁻ or thiocyanate is usually provided in the form of a nucleophilic additive as previously described herein.

Conventionally, the industrial fluorination of aryl compounds is performed either at high temperatures (typically 400-500° C.) by halogen exchange using potassium fluoride as the fluorine source, or alternatively by synthesising an aryl diazonium salt in the presence of anhydrous hydrogen fluoride (HF), or tetrafluoroboric acid followed by thermal decomposition. Following experimentation, it is has now been found that by using hydrophobic ionic liquids, a substantially anhydrous solution of an aryl diazonium salt can be produced which can then be further reacted to form a fluorarene by thermal decomposition. The use of hydrophobic ionic liquids as an extractant for the aryl diazonium salts limits the amount of water which is in contact with the aryl diazonium salts once formed with the result that unwanted phenol by-products which are commonly obtained in aromatic nucleophilic reactions are significantly reduced.

The amount of nucleophilic species present in the hydrophobic ionic liquid is typically greater than one equivalent relative to the amount of aryl diazonium salt. It will however be readily appreciated by the skilled addressee that the amount of nucleophilic species will also be determined by process economics.

Once formed the resultant aryl compounds prepared according to either the Balz-Schiemann or Sandmeyer type reactions respectively can be readily isolated from the hydrophobic ionic liquid. Suitable extraction methods include for example azeotropic distillation, evaporation, or vacuum distillation, steam stripping or solvent extraction using a suitable solvent for example diethyl ether or aliphatic hydrocarbons to obtain a stable aryl compound in pure form.

In a preferred embodiment of the present invention comprises a process for performing nucleophilic substitution reactions on aryl diazonium salts or derivatives thereof wherein

in step 1, an aromatic amine is diazotised in an aqueous solvent system to give an aryl diazonium salt,

in step 2, the aqueous solvent system containing the aryl diazonium salt is contacted with a hydrophobic ionic liquid whereby at least a portion of the aryl diazonium salt is transferred from the aqueous solvent system to the hydrophobic ionic liquid,

in step 3, reacting the aryl diazonium salt with an appropriate nucleophilic species in the hydrophobic ionic liquid to give the desired product without the need to first isolate the aryl diazonium salt from the hydrophobic ionic liquid.

In a more preferred embodiment of the present invention comprises a process for performing nucleophilic substitution reactions on aryl diazonium salts or derivatives thereof wherein

in step 1, an aromatic amine is diazotised in an aqueous solvent system to give an aryl diazonium salt,

in step 2, the aqueous solvent system containing the aryl diazonium salt is contacted with a hydrophobic ionic liquid whereby at least a portion of the aryl diazonium salt is transferred from the aqueous solvent system to the hydrophobic ionic liquid,

in step 3, separating the hydrophobic ionic liquid containing the aryl diazonium salt from the aqueous solvent system,

in step 4, reacting the aryl diazonium salt with an appropriate nucleophilic species in the hydrophobic ionic liquid to give the desired product without the need to first isolate the aryl diazonium salt from the hydrophobic ionic liquid.

The aromatic amine, the diazotisation conditions in steps 1, aryl diazonium salt, aqueous solvent system, hydrophobic ionic liquid and nucleophilic species are as hereinbefore described above.

In a further aspect of the present invention is has surprisingly been found that once the hydrophobic ionic liquids have been utilised in one of the reactions outlined above and the desired aryl compounds recovered, it is further possible to isolate and reuse the hydrophobic ionic liquids so lowering the cost of carrying out expensive nucleophilic substitution reactions.

In yet a further aspect of the present invention is has also surprisingly been found that a nucleophile can be reacted with a diazonium salt with a more stable counter-ion in a controlled reaction to give the desired nucleophilic addition product in high yield and high selectivity. Therefore, self-reactive diazonium salts such as for example fluoroborate salts which can be used to form fluoroarenes may be added to ionic liquids containing a desired nucleophilic species (for example bromine, chlorine and nitrile) and reacted to give the desired product. This allows the Sandmeyer reaction to be performed without the use of copper and on more stable, isolable diazonium salts (for example BF₄).

The present invention is further illustrated by way of the following examples:

### EXAMPLE 1

### Conversion of 4,4′-methylenedianiline to bis(4-fluorophenyl)methane

4,4′-Methylenedianiline (1 mmol) was dissolved in HBF₄ (25% by weight, 2 ml) at 0° C. Sodium nitrite (2.1 mmol) (0.145 g) dissolved in distilled water (0.5 ml) was added dropwise to the 4,4′-methylenedianiline. A white precipitate formed and the resultant mixture was stirred for 20 minutes at 20° C. to allow completion of the diazotisation step.

1-Butyl-3-methyl-imidazolium hexafluorophosphates [bmim][PF₆] (2 g) (7 mmol) was then added to the reaction mixture which resulted in the immediate dissolution of the precipitate and separation of the mixture into a yellow hydrophobic ionic liquid layer and a clear aqueous layer.

The clear aqueous layer was removed by decantation. The remaining hydrophobic ionic liquid layer was flushed and dried using dry nitrogen (N₂) and the sample vessel sealed from contact with the atmosphere. The hydrophobic ionic liquid layer was then heated at 90° C. for 90 minutes during which time the ionic liquid turned pink and vigorous effervescence was visible. After cooling, the ionic liquid was extracted with diethyl ether (5×5 mls) and the ethereal extracts reduced in vacuo to give a yellow oil.

The resultant yellow oil was confirmed by ¹H-NMR to be 82% bis (4-fluorophenyl) methane. The overall yield of bis (4-fluorophenyl)methane was calculated to be 75%, based on the initial weight of 4,4′-methylenedianiline.

### EXAMPLE 2

### Conversion of 4-nitroaniline to 4-bromonitrobenzene

4-Nitroaniline (5 mmol, 0.69 g) was dissolved in hydrobromic acid (6.5 mls) (18%, approximately 2.3M) at room temperature and the mixture cooled to 10° C. in an ice bath with stirring. Sodium nitrite (NaNO₂) (5.5 mmol, 0.345 g) was dissolved in distilled water (1 ml) and then added dropwise over 10 minutes to the acidic amine solution whereby nitrous fumes were evolved. The last few drops were added very slowly with vigorous stirring. The mixture was left to diazotise for 30 minutes without allowing the temperature to increase above 10° C.

1-Ethyl-3-methylimidazolium bis(trifluoromethylsulfonyl)imide [emim][NTf₂] was then added to the solution, which resulted in a rapid separation of the mixture into a pale yellow aqueous acidic layer and a dark red ionic liquid layer. The aqueous layer was decanted and no further attempt was made to dry the ionic liquid layer.

1-Butyl-3-methylimidazolium bromide [bmim][Br] (5 mmol) (1 g) was then added to the ionic liquid layer whereby a viscous orange solution was formed. The liquid melt was then heated at 80° C. for 15 minutes of which 10 minutes involved the vigorous evolution of nitrogen. After cooling, the ionic liquid was extracted with diethyl ether (5×5 ml). Reduction of the ether layer in vacuo yielded yellow crystals (0.46 g, 46%). HPLC showed the product to be greater than 90% pure.

The aqueous layer was extracted a second time with [emim][NTf₂] (1 ml, 4 mmol) and [bmim][Br] was again added (2.5 mmol, 0.5 g). The procedure above was repeated for this second extract, yielding yellow crystals (0.20 g, 20%). HPLC showed the product as being greater than 85% pure.

The overall yield for the preparation of 4-bromonitrobenzene comprising diazotisation, extraction and decomposition was 66% with respect to the starting material 4-nitroaniline.

### EXAMPLES 3

### Conversion of 4-nitroaniline to 4-chloronitrobenzene

### EXAMPLE 3a

4-Nitroaniline (5 mmol, 0.69 g) was dissolved in hydrochloric acid (6.5 ml, 9%, approximately 2.3M) at room temperature. The solution was cooled to 10° C. in an ice bath. Sodium nitrite (5.05 mmol, 0.348 g) was dissolved in distilled water (1 ml) and then added dropwise over 10 minutes, the last few drops added very slowly with vigorous stirring. The mixture was left to diazotise for 30 minutes without allowing the temperature to increase above 10° C.

### EXAMPLE 3b

### Extraction with [emim][NTf₂] with addition of [emim][Cl] as chloride source

1-Ethyl-3-methylimidazolium bis(trifluoromethylsulfonyl)imide [emim][NTf₂] (2 ml, 3.1 g, 8 mmol) was added to the solution from part (a) which resulted in a rapid separation of the mixture into a pale yellow aqueous acidic layer and a dark yellow (hydrophobic) ionic liquid layer. The mixture was stirred for 3 minutes to allow extraction of the diazonium salt formed in part (a) into the ionic liquid layer. The aqueous layer was decanted and no further attempt was made to dry the ionic liquid layer. The aqueous layer was again extracted with [emim][NTf₂] (as above) and the fractions combined.

[Emim][Cl] (5 mmol, 0.71 g) was added to the combined fractions and the resultant liquid melt was heated at 80° C. for 90 minutes, (60 minutes of which involved the steady evolution of nitrogen). The melt started to effervesce at 50° C., possibly due to the destruction of the diazonium salt by adventitious water. Once cooled the ionic liquid layer separated into two layers, a lower red ionic liquid layer and an upper aqueous yellow layer (approximately 0.5 mls). White needle crystals of 4-chloronitrobenzene crystallised around the top of the flask were also in evidence suggesting that the removal of water by decantation had not previously removed all of the water on this scale. The aqueous layer was removed and the ionic liquid layer was extracted with diethyl ether (5×5ml). Reduction of the ether layer in vacuo yielded red crystals (0.27 g, 34%). HPLC showed the product to be greater than 75% pure by area. HPLC analysis of the water layer present after the reaction was complete was shown to contain only 4-nitrophenol. Lower yields were obtained using chloride as a nucleophile, compared with the bromide example. This result was expected based on the relative nucleophilicities of the ions.

### EXAMPLE 3c

### Extraction with tetradecyltrihexyl phosphonium chloride

The extraction of the diazonium salt was performed as in part (b) above except using tetradecyltrihexyl phosphonium chloride (2×2 ml, 1.8 g, 3 mmol) as the extractant in place of [emim][NTf₂]. (Tetradecyltrihexylphosphonium chloride floats on water and care has to be taken when decanting the aqueous acid layer. This particular ionic liquid is also very viscous and some loss in yield may occur during decantation). On heating to 80° C. for 90 minutes, evolution of nitrogen started at 60° C. and the reaction stayed yellow throughout. The ionic liquid layer could not be extracted as it is miscible with most conventional organic solvents. HPLC showed no 4-chloronitrobenzene formation but instead an unidentified product and 4-nitrophenol were detected in the ratio of 5.6:1.

### EXAMPLE 4

### Nucleophilic displacement of nitroqen in an ionic liquid

An isolated diazonium salt, 4-nitrobenzenediazonium BF₄ (3 mmol, 0.71 g) was added to dibutyl imidazolium bromide [bbim][Br] (15 mmol, 3.95 g). Dibutyl imidazolium bromide [bbim][Br] is an orange viscous fluid, partially miscible with water and is a liquid at room temperature. The mixture was very viscous and started to evolve nitrogen when warmed to 45-50° C. When the mixture was heated to 80° C. for 30 minutes, a red solution resulted. The liquid was extracted with diethyl ether (3×5 ml). Reduction in vacuo yielded pure 4-bromonitrobenzene (0.108 g, 18%), shown to be greater than 97% pure by HPLC, with no traces of 4-nitrophenol. However, the ionic layer was very viscous and interfacial contact poor, resulting in inefficient extraction. The subsequent addition of water (10 ml) to the ionic layer resulted in precipitation of an orange solid and evolution of nitrogen, suggesting that the reaction had not gone to completion. Extraction of the resulting aqueous layer with diethyl ether (4×5 ml) yielded an orange solid (0.32 g, 53%) which was shown by HPLC to be greater than 80% 4-bromonitrobenzene (that is, formed prior to hydrolysis, but not extracted by the diethyl ether due to viscosity problems). Even so, this un-optimised reaction resulted in greater than 60% conversion to the desired product.

1. A process for performing nucleophilic substitution reactions on aryl diazonium salts or derivatives thereof wherein the aryl diazonium salt is first generated in an aqueous solvent system followed by partitioning of the aryl diazonium salt with a hydrophobic ionic liquid thereby allowing subsequent reaction of the aryl diazonium salt with an appropriate nucleophilic species in the hydrophobic ionic liquid to the desired product without the need to first isolate the aryl diazonium salt.

2. A process for performing nucleophilic substitution reactions on aryl diazonium salts or derivatives thereof wherein
in step 1, an aromatic amine is diazotised in an aqueous solvent system to give an aryl diazonium salt,
in step 2, the aqueous solvent system containing the aryl diazonium salt is contacted with a hydrophobic ionic liquid whereby at least a portion of the aryl diazonium salt is transferred from the aqueous solvent system to the hydrophobic ionic liquid,
in step 3, reacting the aryl diazonium salt with an appropriate nucleophilic species in the hydrophobic ionic liquid to give the desired product without the need to first isolate the aryl diazonium salt from the hydrophobic ionic liquid.

3. A process for performing nucleophilic substitution reactions on aryl diazonium salts or derivatives thereof wherein
in step 1, an aromatic amine is diazotised in an aqueous solvent system to give an aryl diazonium salt,
in step 2, the aqueous solvent system containing the aryl diazonium salt is contacted with a hydrophobic ionic liquid whereby at least a portion of the aryl diazonium salt is transferred from the aqueous solvent system to the hydrophobic ionic liquid,
in step 3, separating the hydrophobic ionic liquid containing the aryl diazonium salt from the aqueous solvent system,
in step 4, reacting the aryl diazonium salt with an appropriate nucleophilic species in the hydrophobic ionic liquid to give the desired product without the need to first isolate the aryl diazonium salt from the hydrophobic ionic liquid.

4. A process according to any one of claims 1 to 3 wherein the aryl diazonium salt is formed by the reaction of nitrous acid with an aromatic amine compound.

5. A process according to claim 4 wherein the nitrous acid is formed by the reaction of an alkali metal nitrite with an acid.

6. A process according to claim 5 wherein the acid comprises an inorganic acid.

7. A process according to any one of claims 2 to 6 wherein the aromatic amine is an optionally substituted aniline compound of Formula (2). 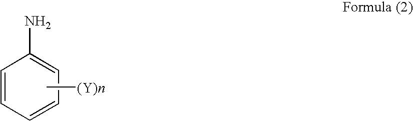
wherein:
Y is an optional substituent as hereinbefore described; and
n is 0, 1, 2 or 3.

8. A process according to any one of the preceding claims wherein the hydrophobic ionic liquid forms a biphasic solution when mixed with the aqueous solvent system.

9. A process according to any one of the preceding claims wherein the hydrophobic ionic liquid is selected from the group comprising [emim][NTf₂] 1-ethyl-3-methylimidazolium bis(trifluoromethylsulfonyl)imide, [bmim][PF₆] N-butylpyridinium hexafluorophosphate, [bbim][Br] 1-dibutyl-3-methy limidazolium bromide, and [C₄DBU]Br carbon tetra-1,8-diazabicyclo[5.4.0]undec-7-ene bromide.

10. A process according to any one of the preceding claims wherein the nucleophilic species which substitutes the aryl diazonium salt comprises fluoride, chloride, bromide, iodide, nitrile or thiocyanate.

11. A process according to any one of the preceding claims wherein the nucleophilic species is present in or forms part of the hydrophobic ionic liquid.

12. A process substantially as herein described with reference to any one of the examples.
